(19) United States
(12) Patent Application Publication
(10) Pub. No.: US 2012/0248165 A1
(43) Pub. Date: Oct. 4, 2012

(54) BIFURCATABLE GOLF BAG

(76) Inventor: Charles Logan Godfrey, Duxbury, MA (US)

(21) Appl. No.: 13/436,966

(22) Filed: Apr. 1, 2012

Related U.S. Application Data
(60) Provisional application No. 61/470,562, filed on Apr. 1, 2011.

(51) Int. Cl. A63B 55/00; B62J 9/00

(52) U.S. Cl. 224/417; 206/315.6

(57) ABSTRACT

A bifurcatable golf and rod bag and bicycle rack system for facilitating easy transport of a golf bag and contents by a human on a bicycle. The golf and rod bag includes a first section that is separable from a second section, wherein each of the first and second sections provide storage for a plurality of golf clubs, the first and second sections being attachable to form a multi-compartment golf bag that includes at least two independent compartments for storing golf clubs. The storage for a plurality of golf clubs items includes a top opening that is divided into a plurality of apertures for receiving a golf club handle.

### BACKGROUND OF THE INVENTION

Golfing is a sport enjoyed by people of all ages around the world. Golf bags come in many forms, but nearly all bags tend to have some limitations when it comes to transporting a golf bag with a bicycle or small engine powered bike. We envision a radical new design for a golf bag and bike transportation system.

### SUMMARY OF THE INVENTION

A BikeGolfBag™ may comprise a lightweight golf bag system that can be separated into easily mountable portions for transport using a conventional rear wheel bike rack, such as one suitable for transport of panniers. The BikeGolfBag™ includes a multi-section golf bag that can be separated into at least two portions (e.g. vertically (top to bottom), from front to back or side-to-side). The multi-section golf bag when configured in “golf” mode looks and handles much like a traditional lightweight carry-type golf bag. When the multi-section golf bag is configured in “bicycle” mode, the bag looks and handles similarly to a traditional bicycle pannier In addition, embodiments of the BikeGolfBag™ optionally includes a supplementary storage bag that can be mounted on the bike rack substantially between the separated upper extending sections of the multi-section golf bag when the golf bag is configured in “bicycle” mode and positioned on the bike rack. The supplementary storage bag may be mounted on a horizontal portion of the bike rack that may be disposed over the rear tire of the bicycle.

The BikeGolfBag™ provides significant benefits including allowing a golfer, caddie, other golf related professional (e.g. golf club service person, golf course pro, and the like) or bicyclist to travel to and from a golf course, golf resort, practice field (driving range, putting green), golf shop, and the like by bicycle while carrying golf clubs and related items (e.g. balls, tees, score cards, clothes, cleats, visors, and the like) in a convenient, balanced, bicycle-safe, light-weight golf bag system. The supplementary storage bag may give the golfer/bicyclist and the like an added option of packing a few days clothing, food or the like to facilitate enjoying the freedom to take extended multiple day tours. The BikeGolfBag™ is environmentally clean, conserves fuel, leaves no carbon footprint during use and promotes health and fitness through the use of a bicycle to travel to and/or traverse a golf course.

In an aspect of the invention, methods and systems described herein may include a transportable golf bag system that may include a first section that is separable from a second section, wherein each of the first and second sections provide independent storage for a plurality of golf clubs and accessories, the first and second sections being attachable to form a multi-compartment golf bag. The multi-compartment golf bag may include at least two independent compartments for storing golf clubs. Also, when separated, the first and second golf bag sections may be configured to be disposed in a bicycle rack that is adapted to facilitate transporting the golf bag via a bicycle.

In another aspect of the invention, methods and systems described herein may include golf bag system that may include a first and second vertically elongated section, wherein each section provides storage for a plurality of golf clubs and accessories; a bag attachment means for removably attaching the first and second sections together to form a single golf bag and for attaching each section to a bicycle rack. The methods and systems may further include a bicycle rack for providing support to the first and second sections and for facilitating attaching each section to the bicycle rack with the bag attachment means. The first and second vertically elongated sections each may comprise a first interior region and a top opening thereto for holding golf clubs. The top opening may facilitate access to golf clubs held in the first interior region. The bag attachment means may include hook and loop releasable closure fabric. Alternatively the bag attachment means may comprise a strap fixedly attached to the first section and removably attachable to the second section.

In yet another aspect of the invention, methods and systems described herein may include a means for transporting a golf bag that may include separating a first section of the golf bag from a second section of the golf bag, forming two independent golf bag sections each providing storage for a plurality of golf clubs and accessories; disposing a golf bag rack over a rear wheel of a bicycle, the rack being attached to the bicycle to provide support to the golf bag sections while allowing free movement of the rear wheel; positioning the first section of the golf bag on the rack on a first side of the rear tire; positioning the second section of the golf bag on the rack on a second side of the rear tire; and fastening the first and section sections of the golf bag to the rack.

Methods and systems described herein may include a transportable golf bag, that may include a first section that is separable from a second section, wherein each of the first and second sections provide storage for a plurality of golf clubs, the first and second sections being attachable to form a multi-compartment golf bag. The multi-compartment golf bag includes at least two independent compartments for storing golf clubs. The storage for a plurality of golf clubs items includes a top opening that is divided into a plurality of apertures for receiving a golf club handle. The first and second sections are configured to be disposed on a bicycle rear-wheel rack and secured to the bicycle rack in a substantially vertical orientation for transporting the golf bag via a bicycle. At least one of the first and second sections includes storage for a plurality of golf accessories

Methods and system described herein may include a golf bag that may include a first and second vertically elongated section, wherein each section provides storage for a plurality of golf clubs; a bag attachment means for removably attaching the first and second sections together to form a single golf bag; and a rear-wheel bicycle rack attachment means for independently attaching each of the first and second vertically elongated sections to a bicycle rack. The rear-wheel bicycle rack attachment means comprises at least one inverted j-hook for attaching over a horizontal member of the bicycle rack and at least one member for receiving a j-hook end of a cord. The rear-wheel bicycle rack attachment means comprises at least one inverted j-hook disposed above a vertically oriented keyhole adapted to engage a pannier tie-down knob of the bicycle rack. The rear-wheel bicycle rack attachment means comprises at least one inverted j-hook disposed above a stretchable cord adapted to engage pannier tie-down knob of the bicycle rack. The first and second vertically elongated sections comprising a first interior region and a top opening thereto for holding golf clubs in a substantially vertical orientation. Wherein the top opening includes dividers to facilitate access to golf clubs held in the first interior region.

In these methods and systems described herein the bag attachment means includes hook and loop releasable closure fabric. The bag attachment means comprises a strap fixedly attached to the first section and removably attachable to the second section. The bag attachment means comprises a hook and loop strap fixedly attached to the first section and an aperture on the second section for receiving the strap. The aperture comprises an adjustable loop.

In the methods and systems described herein, a bicycle transportable bag, may include a first elongated section that is separable from a second elongated section, wherein each of the first and second elongated sections provide storage for a plurality of elongated items, the first and second elongated sections being attachable to form a multi-compartment transportable bag, wherein the storage for a plurality of elongated items includes a top opening that is divided into a plurality of apertures; and a first side of the first and second elongated sections comprising at least one inverted j-hook and a means for facilitating securing elongated section to a rear-wheel bicycle rack. The means for facilitating securing the elongated section facilitates orienting the section so that the plurality of elongated items is transportable in a substantially vertical orientation.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 a perspective view of the bifurcatable golf and rod bag as described herein configured on a rear wheel bike pannier rack.

FIG. 2 perspective top view of the bifurcatable golf and rod bag showing left and right portions and a divided opening.

FIG. 3 depicts a side view of the bifurcatable golf and rod bag fully assembled.

FIG. 4 depicts a detailed view of a handle and assembly strap and ring.

FIG. 5 depicts a view of the mating surface of the left and right bifurcatable golf and rod bag portions with bike rack attachment features.

FIG. 6 depicts a detailed view of the bike rack attachment features.

FIG. 7 depicts a first side view of the bifurcatable golf and rod bag with top cover and backpack straps.

FIG. 8 depicts a second side view of the embodiment of FIG. 7.

FIG. 9 depicts a side view of the bifurcatable golf and rod bag with attachment straps and rings.

### DETAILED DESCRIPTION OF THE PREFERRED EMBODIMENT(S)

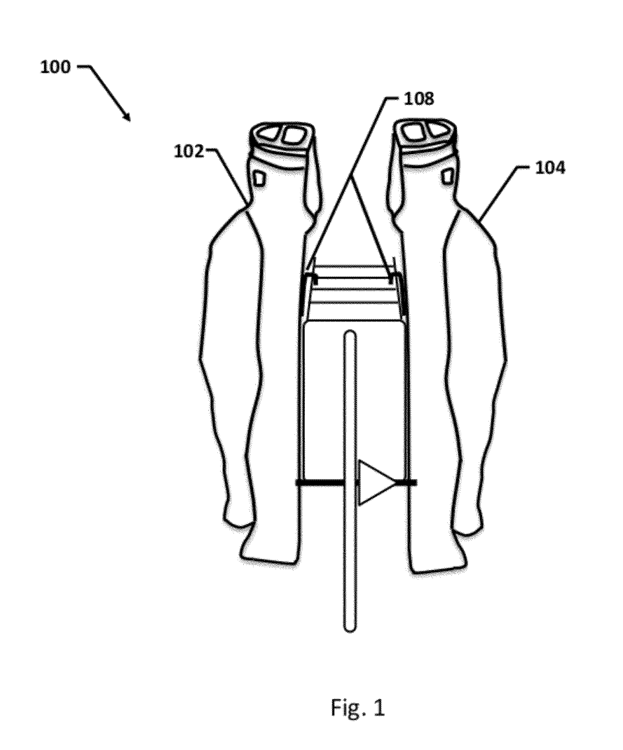

Referring to FIG. 1, which is a perspective view of the bifurcatable golf and rod bag 100 as described herein configured on a rear wheel bike pannier rack, a left portion 102 and a right portion 104 are shown detached from each other in bicycle mode. When left portion 102 and right portion 104 are detached from each other, the may be assembled onto a rear wheel bike rack/pannier holder by placing J hooks 108 over the top side portions of the bike rear wheel rack and optionally attaching a stretchable cord (e.g. BUNGEE) to two rings that are disposed below the J hooks 108 and extending a mid section of the stretchable cord down over knobs that are attached to the bicycle, such on the bicycle frame in close proximity to the rear wheel axle. The stretchable cord may come attached to the rings below the J hooks 108 or may be attachable/removable.

When assembled onto a rear wheel bike pannier rack, the left portion 102 and the right portion 104 may be individually attached to opposite sides of the bike rack so that one portion (e.g. the left portion 102) is attached to the left side of the bike rack and a second portion (e.g. right portion 104) is attached to the right side (e.g. drive chain side) of the bike rack. By placing the bifurcatable golf and rod bag 100 so that the J hooks 108 come down over the bike rear wheel rack, the bag 100 may remain substantially upright with an open top portion above the rack and the bottom closed portion below the pannier knobs. In this configuration, the bifurcatable golf and rod bag 100 can safely and conveniently facilitate transport of golf clubs and related gear, fishing rods and related gear, archery arrows and related gear, rolled or tubed architectural drawings, and any other narrow elongated object such as a flag pole, a baseball bat, a field hockey stick, an ice hockey stick, a polo mallet, a crochet mallet, a cricket bat, and the like.

The bifurcatable golf and rod bag that has been separated into a left portion 102 and a right portion 104 may be assembled onto a bike rear wheel rack by attaching a stretchable cord to two rings disposed below the J hooks 108; lifting the portion (e.g. left or right) so that the J hooks 108 face the side of the rear wheel bike rack; and lowing the bag 100 portion down so that the J hooks 108 capture a substantially horizontal side bar of the rear wheel bike rack. The bag 100 may now be secured to the rear wheel bike pannier rack by extending the stretchable cord downward below the pannier knobs that are attached to the bike frame in close proximity to the rear wheel axle and releasing the cord so that it captures the pannier knob, causing tension in the cord and resisting movement of the bag 100 relative to the rack.

An alternative method for assembling a portion of the bag 100 to a bike rack is to attach a stretchable cord to the rings on the bag 100 as described above; bring the bag portion with the cord and J hooks facing a side of the bike rack; raise the bag portion so that the cord captures the pannier knob and the J hooks extend above the bike rack horizontal section; and lower the bag portion so that the J hooks extend over and capture a horizontal side rod of the bike rack. In some embodiments, the stretchable cord may be pre-attached to the bag portion.

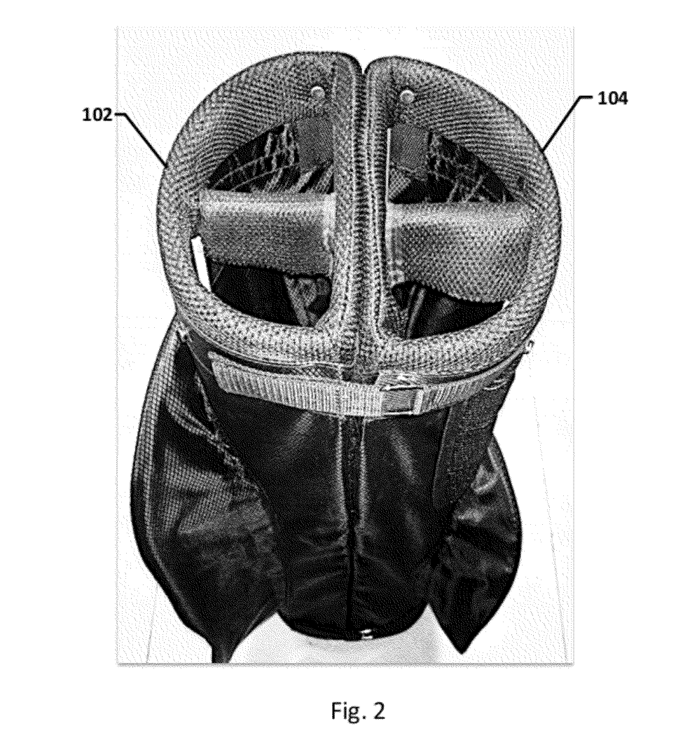

Referring to FIG. 2, a top perspective view of an assembled embodiment of the bifurcatable golf and rod bag, a left portion 102 and a right portion 104 are depicted. Each of the left portion 102 and right portion 104 may include an opening that is divided into a plurality of apertures to facilitate depositing items into each respective bag 100 portions. In a golf example of the bag 100, each divided aperture may facilitate holding one or more golf clubs so that access to the clubs is enhanced. In the embodiment of FIG. 2 the top opening of the left portion 102 and the right portion 104 is divided into two apertures. However, a top opening of a bag portion may be divided into more apertures (e.g. three, four, five, or more), or may not be divided (e.g. one aperture). At least the walls and top surface of the top opening and dividers may be covered with fabric and/or padding to protect the objects being deposited into the bag portion through the top opening. In addition, the object (e.g. golf club handles) may be protected from damage that may occur during transport, such as when the bifurcatable golf and rod bag is attached to a bike rack and transported therewith.

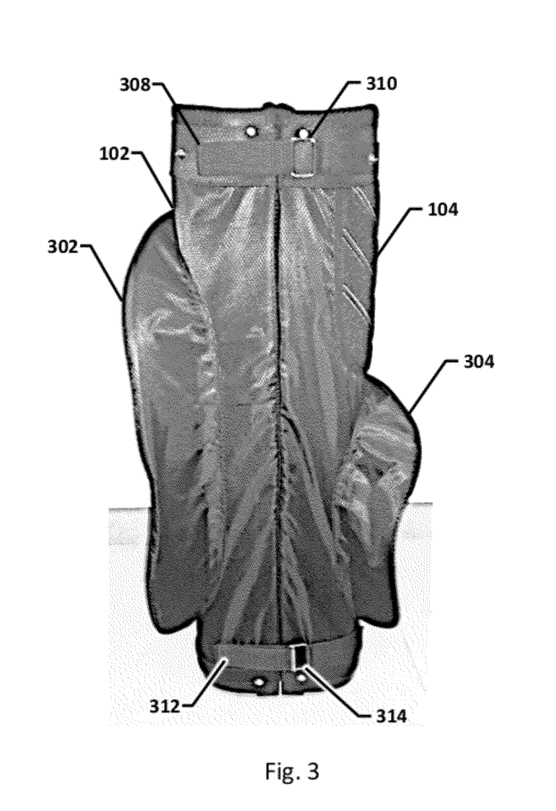

Referring to FIG. 3, a side view of the assembled bifurcatable golf and rod bag is depicted. Left portion 102 and right portion 104 are shown assembled together to form a multi-compartment golf and rod bag. Left portion 102 may further include a separate tall compartment 302 that may be suitable for storage of larger gear or equipment. Right portion 104 may further include a separate medium compartment 304 that may suitable for storage of smaller gear or equipment. Each of tall compartment 302 and medium compartment 304 may have zipper type closures.

FIG. 3 also depicts straps and buckles that may be used to secure the left portion 102 to the right portion 104 to provide an assembled bag 100. Upper straps 308 and lower straps 312 on one of the portions (straps for the left portion 102 are depicted in FIG. 3) may be passed through rings 310 and 314 respectively and attached, such as through hook and loop closure to secure left portion 102 to right portion 104.

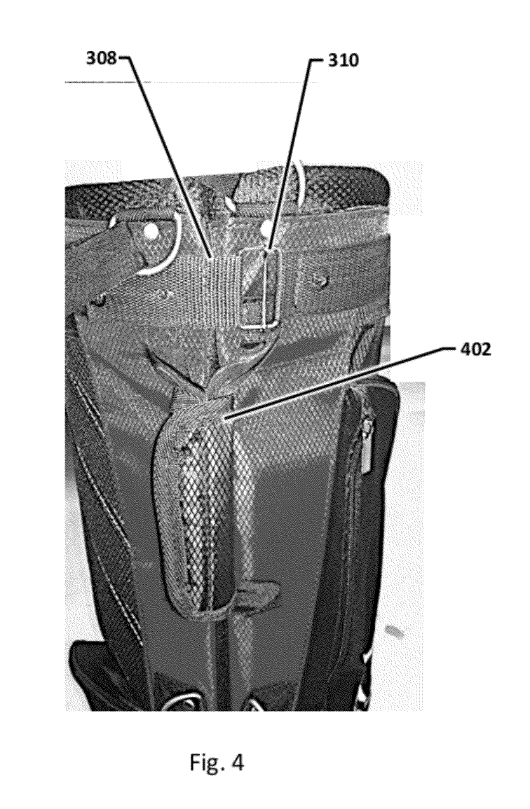

Referring to FIG. 4, which depicts details of the upper strap 308 assembled with upper ring 310 also depicts assembled handle 402. Assembled handle 402 may include a handle clasp that may clasp a pair of handle straps, one handle strap from each of the left and right portions of the bag 100. The pair of handle straps may be disposed near a mating edge of the left and right portions of the bag 100 and aligned so as to allow for convenient gripping of both straps as if they were one strap. The handle clasp of the assembled handle 402 may facilitate carrying of the assembled bag 100 by hand. The handle clasp may be permanently assembled to one of the handle straps and may capture the other handle strap during assembly of the assembled handle 402. Each handle strap may be used to carry each portion of the bag 100 separately when the left portion 102 and the right portion 104 are separated.

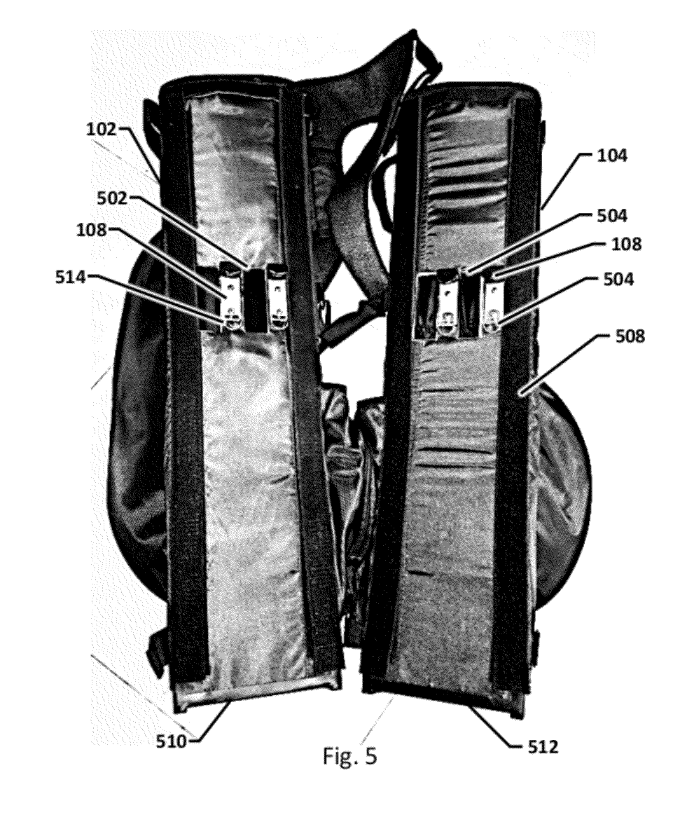

Referring to FIG. 5, the bifurcatable golf and rod bag is depicted in an unassembled or “bicycle” mode that comprises a left portion 102 that is separated from a right portion 104. Left portion 102 may include a left bottom 510 that may be a solid piece shaped to facilitate storage of a plurality of golf clubs, fishing poles, and the like as described above in the description of FIG. 2. Similarly, right side 104 may include a right bottom 512 that may be substantially similar to left bottom 510. A bicycle mount side of the each portion of the bag 100 is shown in FIG. 5. Each portion includes a plurality of strips of hook and look closure 508. The left portion 102 includes a left side bicycle rack attachment bracket 502 and the right portion 104 includes a right side bicycle rack attachment bracket 504. Left and right side bicycle rack attachment brackets 502 and 504 each includes a pair of offset J hooks 108 and a pair of stretchable cord rings 514.

The left portion 102 may be partially fastened to the right portion 104 by mating the hook and loop closure 508 on the left portion 102 to the respective hook and loop closure 508 on the right portion 104. The offset J hooks 108 allow the left portion 102 and the right portion 104 to be assembled without causing interference among the J hooks 108.

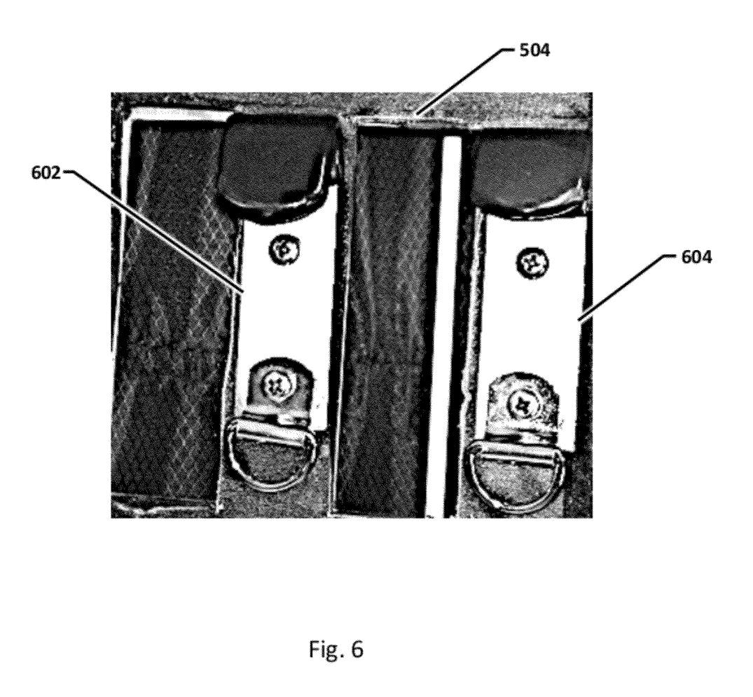

FIG. 6 depicts details of right side bicycle rack attachment bracket 504. Bracket 504 may comprise an inner J hook/ring assembly 602 and an outer J hook/ring assembly 604. Bracket 504 may be attached to the right portion 104 structural frame. Although not depicted, left side bicycle rack attachment bracket 502 would be described substantially the same as bracket 504 except for the locations of the J hook/ring assemblies to facilitate interleaving the left and right side J hooks when the left portion 10 and the right portion 104 are attached to each other to form an assembled bag 100. The left side bicycle rack attachment bracket 502 and the right side bicycle rack attachment bracket 504 may be constructed out of steel, aluminum, an alloy, or other suitable rigid material.

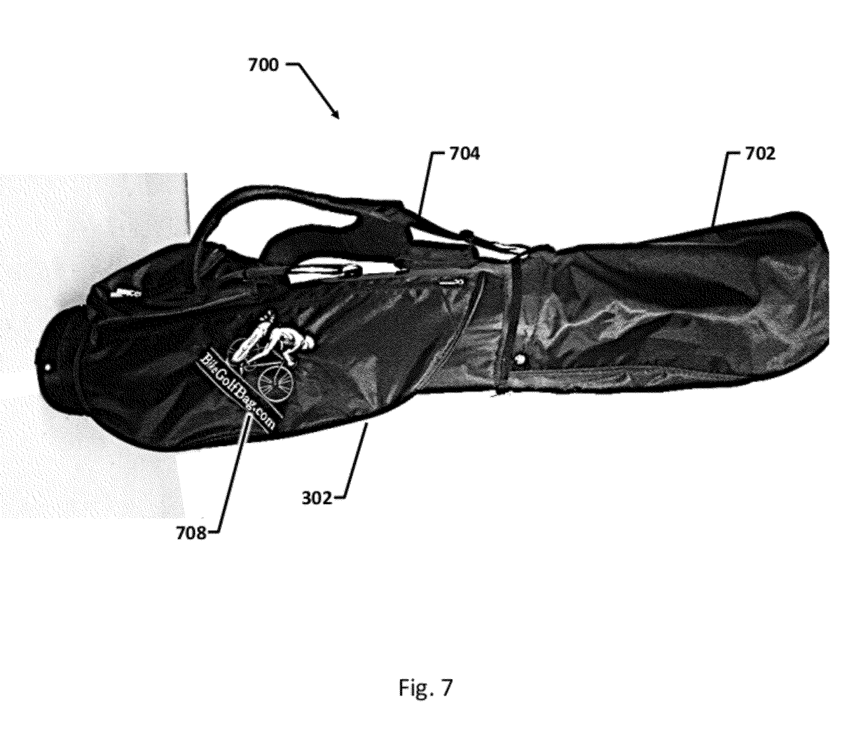

FIG. 7 depicts a left side view of the assembled bag 100 and includes a rain cover 702 to facilitate protecting golf clubs or any other item being transported by the bag 100 from environmental conditions such as rain. The assembled bag 100 of FIG. 7 further depicts a backpack-style set of straps 704 to facilitate carrying the assembled bag 100 on one's back. A logo area 708 for fixed or customized logos is also provided on the tall compartment 302.

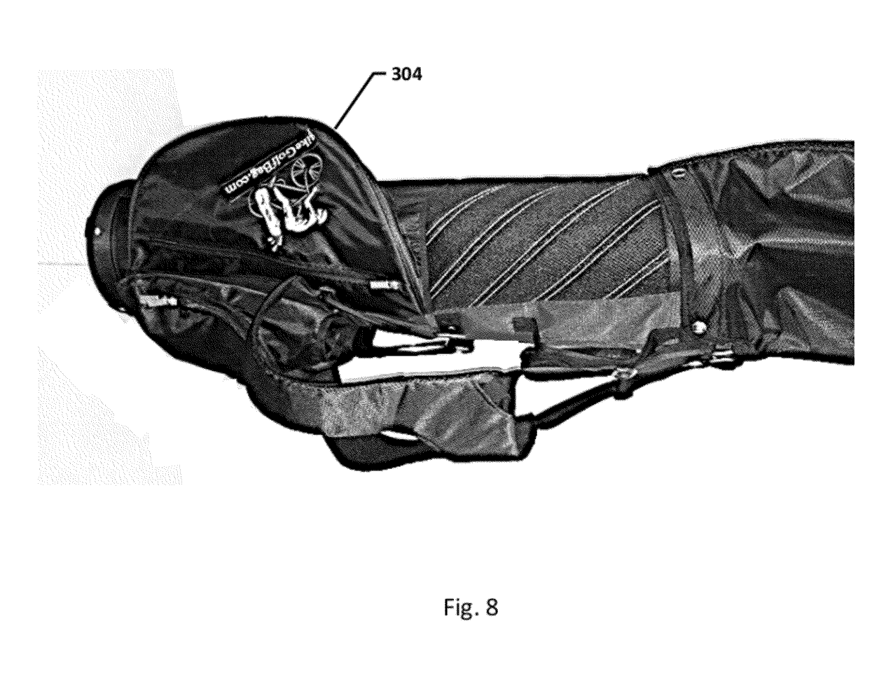

FIG. 8 depicts a side view of a portion of right side 104 of the assembled bag 100 including a logo area on the medium compartment 304.

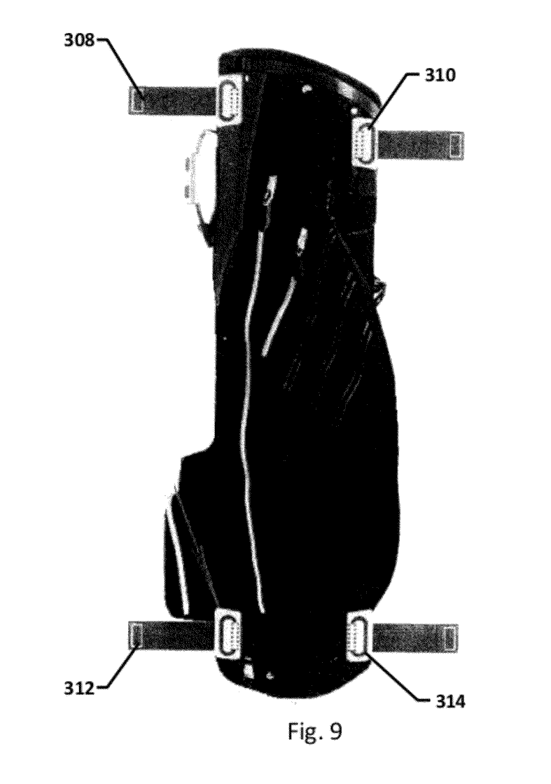

FIG. 9 depicts a second side view of the bifurcatable golf and rod bag 100 including a view of upper attachment straps 308 and rings 310 and lower attachment straps 312 and rings 314 for each of the left and right sides.

In embodiment the left and right sections of the golf bag may attach to be configured in “golf” mode and may also individually attach to a conventional bike rack using a J hook and a metal ring with stretchable cord. One end and a portion of the strap portion of a closure unit may be fixed permanently attached (e.g. stitched) to a first section of the golf bag with the hook and loop closure side facing away from the bag. To attach the first section of the bag to the second section, the opposite end of the strap may be loose so that it can be configured to slide through a metal ring that may be attached to a second section of the golf bag and then may be pulled back to robustly attach to the fixed portion of the strap. There may be a plurality of closure units. In an example there may be four such closure units (top, bottom, front and back). In another example there may be pairs closure units vertically offset at each of four attachment areas. The pairs of closure units may be attached to opposite sections of the bag to enable secure section attachment by working from opposite directions. Therefore in an embodiment, there may be a total of eight attachment units.

The bifurcatable golf and rod bag may comprise a frame that may include a top opening portion, a bottom plate, and vertical rods that hold the top opening portion at a substantially fixed distance and orientation from the bottom plate. This frame may comprise metal, plastic, composites (e.g. carbon fiber, and the like) or combination there of. The top opening portion and the bottom plate may be molded, such as from a plastic type material and/or may be fabricated, machined, or otherwise constructed.

The bag 100 may include a fabric shell laid over and attached to the frame. The fabric shell may be water resistant (e.g. nylon), water proof, tear resistant, stain resistant, and the like.

The bifurcatable golf and rod bag may be used with a variety of vehicles in addition to the bicycle rear wheel rack described herein. Suitable rack or attachment elements that include a stable horizontal bar or other member disposed above and approximately two feet away from a knob or other protrusion configured to facilitate stretching a stretchable cord upward toward the horizontal member may be configured on such a variety of vehicles. Exemplary vehicles include an electric two-wheeled bike, a tricycle, a tandem bicycle, a golf cart, a road bike, a motorcycle, a mountain bike, a hybrid bike, and the like.

In addition to use as a multi-compartment golf bag, the bifurcatable golf and rod bag 100 may be used to transport: fishing rods and gear (e.g. reels, line, nets, and the like) by depositing the rods into one or more of the compartments through the top opening; archery arrows, bows, and gear; architectural drawings rolled up and/or rolled inside a long narrow tube; and the like. Other uses include bicycle couriers in general; a golf pro traveling to a lesson or on a golf course; in lieu of a golf cart on a golf course; bike touring of golf courses; and the like. One intended use, among others is to provide a system allowing a person to travel via bicycle with a golf bag to and from the golf course or for multiple day trips. The bifurcatable golf and rod bag 100 may facilitate a new form of golfing in which the golfers use bicycles to quickly travel from shot to shot on the course, effectively performing a speed round of golf

The bifurcatable golf and rod bag 100 may be made available to the public through a variety of sales channels including retailers (e.g. golf shops), mail order, phone order, on-line ordering, rental (e.g. through bike touring provisioners), and the like.

The bifurcatable golf and rod bag 100 may facilitate social networking opportunities through websites and other electronic communication means (sms, blogging, mobile networking, and the like) that cater to bicycle riding golfers, specific competitions for bicycle golfers, sharing of photos and experiences (e.g. touring by bicycle to golf courses in a geographic region), and the like.

An section mating panel that is not directly visible when the golf bag is configured in “golf” mode may be made of a light-weight yet durable material, such as molded plastic or rubber, carbon fiber, reinforced fabric, mesh and the like. The mating panel may form an outer surface when the golf bag is configured in “bicycle” mode. To assist in keeping the two sections from slipping or moving when in “golf” mode the closure units may be supplemented with an aligning/locking lug system. In an example the locking lug system may include a male portion on extending from substantially the same side as the mating panel on one section and a female portion aligned to receive the male portion on the same side as the mating panel of the second section.

In an example, the left section of the bag may have 4 (two at the top and 2 at the bottom) male lugs. The lugs may be created in the molding process therefore may be a part of the mating panel. The male lugs may be half moon shaped and rounded, measure approximately one inch at the radius and protrude approximately one-half inch from the panel. The female portion may be a round inverted ½ moon disposed on the same side as the mating panel (may be configured into the mating panel) and may be configure to fit the male part.

1. A transportable golf bag, comprising:
a first section that is separable from a second section, wherein each of the first and second sections provide storage for a plurality of golf clubs, the first and second sections being attachable to form a multi-compartment golf bag.

2. The bag of claim 1, wherein the multi-compartment golf bag includes at least two independent compartments for storing golf clubs.

3. The bag of claim 1, wherein the storage for a plurality of golf clubs items includes a top opening that is divided into a plurality of apertures for receiving a golf club handle.

4. The bag of claim 1, wherein the first and second sections are configured to be disposed on a bicycle rear-wheel rack and secured to the bicycle rack in a substantially vertical orientation for transporting the golf bag via a bicycle.

5. The bag of claim 1, wherein at least one of the first and second sections includes storage for a plurality of golf accessories.

6. A golf bag comprising:
a first and second vertically elongated section, wherein each section provides storage for a plurality of golf clubs;
a bag attachment means for removably attaching the first and second sections together to form a single golf bag; and
a rear-wheel bicycle rack attachment means for independently attaching each of the first and second vertically elongated sections to a bicycle rack.

7. The bag of claim 6, wherein the rear-wheel bicycle rack attachment means comprises at least one inverted j-hook for attaching over a horizontal member of the bicycle rack and at least one member for receiving a j-hook end of a cord.

8. The bag of claim 6, wherein the rear-wheel bicycle rack attachment means comprises at least one inverted j-hook disposed above a vertically oriented keyhole adapted to engage a pannier tie-down knob of the bicycle rack.

9. The bag of claim 6, wherein the rear-wheel bicycle rack attachment means comprises at least one inverted j-hook disposed above a stretchable cord adapted to engage pannier tie-down knob of the bicycle rack.

10. The bag of claim 6, wherein the first and second vertically elongated sections comprising a first interior region and a top opening thereto for holding golf clubs in a substantially vertical orientation.

11. The bag of claim 10, wherein the top opening includes dividers to facilitate access to golf clubs held in the first interior region.

12. The bag of claim 6, herein the bag attachment means includes hook and loop releasable closure fabric.

13. The bag of claim 6, herein the bag attachment means comprises a strap fixedly attached to the first section and removably attachable to the second section.

14. The bag of claim 6, wherein the bag attachment means comprises a hook and loop strap fixedly attached to the first section and an aperture on the second section for receiving the strap.

15. The bag of claim 14, wherein the aperture comprises an adjustable loop.

16. A bicycle transportable bag, comprising:
a first elongated section that is separable from a second elongated section, wherein each of the first and second elongated sections provide storage for a plurality of elongated items, the first and second elongated sections being attachable to form a multi-compartment transportable bag, wherein the storage for a plurality of elongated items includes a top opening that is divided into a plurality of apertures; and
a first side of the first and second elongated sections comprising at least one inverted j-hook and a means for securing each elongated section to a rear-wheel bicycle rack.

17. The bag of claim 16, wherein the means for facilitating securing the elongated section facilitates orienting the section so that the plurality of elongated items are transportable in a substantially vertical orientation.

18. The bag of claim 16, wherein the first and second elongated sections are suitable for accepting a plurality of golf clubs, fishing rods, archery arrows, and baseball bats.
